(19) United States
(12) Patent Application Publication
(10) Pub. No.: US 2006/0179961 A1
(43) Pub. Date: Aug. 17, 2006

(54) Water test sample retrieval tool

(76) Inventors: Robert L. Schaub, Hanford, CA (US); Kenneth P. Riley, San Jose, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/355,139

(22) Filed: Feb. 14, 2006

Related U.S. Application Data
(60) Provisional application No. 60/653,745, filed on Feb. 16, 2005.

(51) Int. Cl. G01N 1/12

(52) U.S. Cl. 73/864.63

(57) ABSTRACT

A tool for obtaining a sample of water from a specified depth in a body of water such as a pool, spa or the like while preventing the inflow of water from the surface and other depths. The tool has an elongated handle having one or more handle sections, an inlet section having a downwardly facing inlet, an outlet section having an outlet for pouring water into a chemical test container and a fluid storage section, defined by a tubular member, disposed between the inlet and outlet sections. Preferably, the handle includes a depth marker to identify the depth at which to obtain the water sample. The upper end of the handle has a pressure control hole for use to prevent the entry of water into the tool until the inlet is at the desired depth in the water. The tool quickly and easily obtains the desired water sample.

### CROSS-REFERENCE TO RELATED APPLICATIONS

This application claims the benefit of U.S. Provisional Application No. 60/653,745 filed on Feb. 16, 2005.

### BACKGROUND OF THE INVENTION

A. Field of the Invention

The field of the present invention relates generally to tools utilized for evaluating the chemical make-up of a body of water, particularly swimming pools and the like, by obtaining a water sample from a desired depth in the water for subsequent chemical analysis. In particular, the present invention relates to such water test sample retrieval tools that are configured so the user does not have to kneel down or significantly bend over to obtain the water sample from the desired depth. Even more particularly, the present invention relates to such water test sample retrieval tools that are configured to assure that the retrieved sample only contains water from the desired depth of water.

B. Background

Often it is necessary or desirable to test the chemical composition of a body of water to determine if further action, such as adding chemicals or other materials, is necessary in order to maintain or improve its chemical balance. As is well known, one body of water that is commonly subject to having its chemical composition analyzed is a swimming pool. Unfortunately, the chemical make-up of swimming pool water is easily affected by anything that comes into contact with the water, including rainwater, water run-off and the number of swimmers, and by the displacement of water caused by evaporation. As a result, swimming pool water requires testing at frequent and regular intervals in order to maintain the proper chemical conditions in the water. Swimming pool water is tested for a number of chemical conditions that can affect the interior surfaces of the pool and the pool equipment, such as the pump and pool sweep. Specifically, swimming pool water is commonly tested for acidity, total alkalinity and hardness levels, and less commonly for other chemical indicators. Testing helps to determine whether or not the chemical composition of the pool water is properly “balanced,” such that the water will not harm the pool, pool equipment or swimmers. It is well known that swimming pool owners and caretakers frequently monitor or pay others to monitor the chemical make-up of the pool water to prevent accumulation of harmful chemicals, infestation of algae or the build-up of scale and other precipitates on the inside surfaces of the pool. Depending on weather conditions, such as heat, rain and other environmental considerations, the amount of pool usage and various other factors well known to those who have pools or who are in the pool industry, it may be necessary to test the pool water on a weekly, daily or under extreme conditions an even more frequent basis.

One chemical characteristic of water that is usually always measured when testing pool water, because it typically has the greatest overall effect on the water quality relative to other parameters, is the pH. The pH level of the water affects the efficiency of the pool sanitizier and the overall chemical balance of the water in the pool. As is well known, the pH level of pool water is typically determined by subjecting a test sample of the pool water to a chemical known as phenol red and then comparing the resulting color to a color/pH chart, dipping specially prepared pH test strips into the water or using an electronic pH meter. Depending on the pH level, an acid or a base material is added to the pool water to lower or raise the pH to the desired level (i.e., typically 7.2-7.8). Another water characteristic commonly measured for pools and the like, is the level of alkalinity, which acts as a buffer to prevent the pH of the pool water from wildly fluctuating. An alkalinity test generally requires subjecting a portion of the test sample to titration by adding a dye to the water sample and then adding an acid until a color change is noted. Test strips are also available for alkalinity testing. Another characteristic of the pool water that is usually measured is the hardness of the water, which is a determination of the amount of calcium and magnesium that is present in the water. Water that is too “soft” (i.e., below 60 ppm) will attempt to become hard by dissolving minerals from the environment, such as the pool wall. Hardness can also be measured by subjecting a sample of the water to titration or test strips. The total dissolved solids content of the pool water is an indicator of the amount of materials dissolved in the water. High total dissolved solids levels can result in algae growth. In addition to the above, pool water is also tested for levels of copper, iron and cyanuric acid, which are utilized as a conditioner to help inhibit the sun's ultra violate rays from breaking down the chlorine that is used in pool water.

In order to perform the aforementioned tests, as well as most other tests that may be required or desirable, it is generally necessary to obtain a water test sample from the swimming pool or other body of water. Because the test sample will be subject to the various chemical tests and analysis to determine whether to add chemicals or initiate other treatment procedures, it is important that the test sample be as an accurate representation of the chemical condition of the body of water as possible. To obtain an accurate representative fluid test sample, those in the swimming pool industry and others involved in testing water know it is strongly preferred to obtain the test sample from a location that is somewhat below the surface of the water and away from the pool's inlet and water return lines. As is well known, sunlight and various surface environmental conditions are known to negatively affect the accuracy of water samples that are taken from near the surface of the water. Chemical tests that are performed on water test samples taken from at or near the surface of the water body or near a water inlet or outlet, such as the pool pump or filtration system, is very likely to provide inaccurate and unreliable chemical data. Corrective action, such as the withholding or addition of chemicals to the water, is likely to be ineffective and even potentially harmful to the swimmers as well as the swimming pool structure and equipment.

As previously explained, the ideal sample should be from a depth that is sufficiently below the surface of the water to avoid the inaccuracy problems associated therewith. Specialists in the swimming pool industry recommend the user or tester obtaining the water test sample from a depth of at least twelve to eighteen inches below the surface of the water. To simplify the procedure for the average user, many pool test kit suppliers recommend obtaining the sample from “elbow” depth, meaning the depth below the surface when the person's elbow is at the surface of the pool. Typically, in order to obtain a water sample from the preferred depth below the surface of the water, the person obtaining the water test sample must manually lower the water collection device in his or her hand to the desired depth, let water into the device and then close off the device so that the water from the depth remains in the device. A commonly utilized device is a water bottle or tube configured so the user can close off the inlet of the bottle with his or her thumb or finger. When used to obtain a water sample from a swimming pool, the user generally either kneels or lays down on the deck of the pool so that he or she can reach into the water a sufficient amount to collect water from the desired depth. As known to those who have swimming pools or those who otherwise maintain swimming pools, kneeling or laying on the pool deck can be quite uncomfortable. For persons who have weak, injured or otherwise limited mobility in their knees, hips and/or back, this process can be somewhat painful. This may be particularly true for older persons. Even for healthy persons or those who frequently obtain water samples, such as those in the water testing business, the repeated task of kneeling or laying down to get a water test sample can be quite trying, as well as time consuming. In addition, the surface around the pool can be hot, rough or otherwise somewhat uncomfortable to lie or kneel down on. The difficulty with kneeling or otherwise getting near enough to the surface of the water so as to lower the collection device to the preferred depth in the water often results in the user reducing his or her effort and/or pain by collecting a sample that is nearer the surface than is recommended or desired. As a result, the tests performed on the test sample are often inaccurate and result in an ineffective or damaging response.

Over the years, a number of devices for obtaining water samples from below the water surface have been patented. For instance, U.S. Pat. No. 5,589,648 to Valbuena discloses a test kit gripping apparatus having a tubular handle with a retaining bracket mounted thereon that is adapted to receive and securely grip a water testing kit for lowering the testing kit to the desired depth in a pool or spa for the purpose of sampling the water. U.S. Pat. No. 4,083,253 to Nienow discloses a fluid sampling apparatus having a pivoting platform attached at the lower end of an elongated handle and a lever near the upper end of the handle. The platform is configured to receive a sample collection vessel in an inverted position and the lever is operated to pivot the platform from the inverted position to an upright position to receive fluid into the vessel at the depth of the platform. U.S. Pat. No. 3,692,490 to Hall discloses a pool water tester having a rod with a housing mounted at one end thereof that receives a pair of cylinders and a moveable sleeve that, when operated by a handle, causes water to be drawn into the cylinders from the depth in the pool at which the housing is positioned. As samples of pool water are drawn into the cylinders, a mechanism in the housing injects a testing reagent into the water samples. U.S. Pat. No. 4,454,775 to Ellis discloses a chemical tester for pools that comprises a sample holder at the lower end of elongated handle member and a lever at the upper end of the handle member. The lever pivots the sample holder, in which is placed one or more inverted sample tubes, to move the sample tubes to an upright position and collect water samples at the depth to which the sample holder is positioned. U.S. Pat. No. 4,869,118 to Keller discloses a water retriever having an elongated handle with a covered container at the lower end thereof and a vertical moveable lift cooperatively configured with the handle that is operated to remove the cover to admit water into the container from the desired testing depth. U.S. Pat. No. 5,537,881 to White discloses a fluid sampling device having an elongated tube having a check valve near the bottom of the tube that is configured to open so as to allow water into the tube from the desired depth and then close so the tube can be removed to test the sample of the fluid collected in the tube.

The major disadvantage associated with many devices used to obtain water samples from a pool or other body of water is that the water sample obtained by the device is usually not a true representation of the water from the desired depth needed for an accurate evaluation. Generally, this is due to the device being improperly used or configured in such a way as to make it difficult to obtain a sample of water that is not contaminated with water from the surface of the swimming pool or other body of water. As is well known, an empty receptacle that is placed beneath the surface of a fluid will fill with a mixture of fluid from both the surface as well as from the below the surface unless there is a mechanism to displace or otherwise prevent the surface water from in-filling the receptacle as it is lowered into the body of water. Even though some prior art devices purport to collect water from a selected depth, in reality they collect a sample of fluid that is from a mixture of depths, including the surface. Other prior art devices that attempt to limit the collection of the fluid sample to a specified depth are either complicated to operate or relatively expensive to manufacture, or both.

What is needed is an improved tool for retrieving water samples that, in a simple and effective manner, allows the user to obtain a water sample from the desired depth of a body of water to improve the accuracy of chemical tests performed on the sample. Specifically, what is needed is a water sample retrieval tool that is easy to use and configured to allow a wide population of users with diverse physical abilities obtain a water test sample from a desired depth without the difficulty associated with kneeling or laying near the water surface and inserting their arm into the water. The desired tool should provide a mechanism to ensure that the sample of water obtained is from the desired depth and not contaminated with water from varying depths, particularly from at or near the surface of the body of water. The preferred sample retrieval tool should also be configured to allow the user to pour water from the tool into standard test kit bottles or other testing containers. The preferred tool should also be configured to be lightweight, easy to use and store and adaptable for relatively inexpensive manufacturing.

### SUMMARY OF THE INVENTION

The water test sample retrieval tool of the present invention provides the benefits and solves the problems identified above. That is to say, the present invention discloses a water test sample retrieval tool that simplifies and quickens the task of obtaining a water sample from the desired depth in a body of water to improve chemical test accuracy. The water test sample retrieval tool of the present invention is easy to use, relatively inexpensive to manufacture and is configured to allow a wide population of users with diverse physical abilities to obtain a test sample from the desired depth. Specifically, the water test sample retrieval tool of the present invention allows the user to obtain a water sample from the desired depth without the difficulty associated with kneeling or laying near the edge of the body of water and inserting an arm therein. Even more specifically, the water test sample retrieval tool of the present invention ensures that the water test sample contains only water from the desired depth that is not contaminated with surface water or water from other depths.

In one general aspect, the water test sample retrieval tool of the present invention has an elongated tubular handle having a closed upper end and an open lower end that connects to an inlet section having an inlet for receiving a sample of fluid from the body of fluid. The opposite end of the inlet section connects to one end of a fluid storage chamber, which in the preferred embodiment is defined by a tubular member, that connects at its opposite end to an outlet section, thereby disposing the fluid storage chamber between the inlet and outlet sections. In a preferred embodiment, the handle is made up of two or more connected tubular members that are threadably connected to define the handle and the inlet is disposed generally outwardly and downwardly from the longitudinal axis of the handle. Fluid from the body of fluid enters the tool through the inlet at the inlet section and flows into the fluid chamber, where it is held until the user pours the fluid sample into a chemical test kit or other container through the outlet. The handle has a mechanism for controlling the pressure therein so fluid from the surface or between the surface and the desired sample depth does not substantially enter the fluid storage chamber, which would contaminate the sample from the desired depth. In the preferred embodiment, the mechanism is a pressure control hole in the tubular handle, preferably at or near the closed upper end of the handle. In one embodiment, a cap member closes the upper end of the handle and the pressure control hole is disposed in the cap member. The pressure control hole is sized and configured for the user to place his or her thumb or finger over the hole while lowering the tool into the body of fluid. The preferred embodiment of the tool includes a depth marker to indicate when the inlet is at or near the desired depth in the body of fluid from which to obtain the fluid sample. The preferred embodiment also includes a base member, support members or other mechanisms that are configured for supporting the tool in a generally upright position when placing the tool on a flat surface, such as a table, chair or deck.

In use to obtain a water test sample from a pool, the user first connects any tubular handle members together to form the elongated handle of sufficient length so the user does not have to kneel down, bend over or lay at the edge of the pool in order to obtain the water sample. Once the user connects the handle together, he or she places either the thumb or a finger over the pressure control hole and then lowers the tool into the pool. Once the depth marker is lowered to the surface of the water, thereby placing the inlet at or near the desired depth in the water from which to obtain the sample, the user releases his or her thumb or finger from the pressure control hole to allow water to flow into the storage chamber through the inlet. Once the sample is obtained, the user pulls the tool out of the water. Any water in the handle above the inlet will drain out of the tool into the pool through the inlet. The user then sets the tool on its base or other support members, opens the outlet and pours water from the storage chamber into a chemical test kit or other container to perform the desired chemical tests. If desired, the user may disconnect one or more of the handle sections from the tool to more easily pour water from the storage chamber. In general, the same procedures are utilized when water test sample retrieval tool of the present invention is used to obtain a sample of fluid from other bodies of fluid, including spas, lakes, rivers and the like.

In a preferred embodiment, the water test sample retrieval tool of the present invention is configured to be lightweight and easy to use, allowing the user a convenient and accessible means for collecting a water test sample from a swimming pool or other body of water for analysis. Preferably, the various components that make up the water test sample retrieval tool are manufactured out of materials that are durable, lightweight and corrosion and UV light resistant, such as plastics, PVC and certain composite materials, for use in wet, outdoor environments.

Accordingly, the primary objective of the present invention is to provide an improved water test sample retrieval tool that provides the benefits described above and overcomes the disadvantages and limitations which are associated with presently available tools for obtaining water test samples from the desired depth.

An important objective of the present invention is to provide a water test sample retrieval tool that allows a user to obtain a water sample from a desired depth which is not contaminated with water in-filled from the surface water of the swimming pool or other body of water.

It is also an important objective of the present invention to provide a water test sample retrieval tool that easily and effectively facilitates retrieval of a water test sample from the recommended or desired depth below the surface of a body of water without the user having kneel or lay near the edge of the body of water and then reach into the water with his or her hand to obtain the sample.

It is also an important objective of the present invention to provide a water test sample retrieval tool that comprises an elongated tubular handle having a downwardly facing inlet at its lower end which receives water into a storage chamber, an outlet for pouring the sample out of the storage chamber and a pressure control hole for controlling the inflow of water through the inlet.

It is also an important objective of the present invention to provide a water test sample retrieval tool that is easy to use, lightweight, collapsible for ease of storage and relatively inexpensive to manufacture.

The above and other objectives of the present invention will be explained in greater detail by reference to the attached figures and the description of the preferred embodiments which follows. As set forth herein, the present invention resides in the novel features of form, construction, mode of operation and combination of processes presently described and understood by the claims.

### BRIEF DESCRIPTION OF THE DRAWINGS

In the drawings which illustrates the preferred embodiments and the best modes presently contemplated for carrying out the present invention:

FIG. 1 is a side view of a water test sample retrieval tool configured according to a preferred embodiment of the present invention showing a base member mounted thereon for supporting the tool in an upright position;

FIG. 2 is an isolated side view of the lower end of the water test retrieval tool of FIG. 1 shown with the base member removed therefrom;

FIG. 3 is a perspective view showing the water test sample retrieval tool of the present invention in use to obtain a water sample from a pool;

FIG. 4 is a top plan view of the cap member at the upper end of the handle of FIG. 1 showing the pressure control hole therein;

FIG. 5 is a side view of an alternative embodiment of the water test sample retrieval tool of the present invention showing integral support members for supporting the tool in an upright position; and

FIG. 6 is a front view of the embodiment of the water test sample retrieval tool shown in FIG. 5.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For purposes of simplifying the present disclosure, the discussion and references herein are generally to use of the present invention to obtain a water test sample from a swimming pool. Those skilled in the art will understand and appreciate, however, that the water test sample retrieval tool disclosed herein is not so limited, namely that it can be utilized to obtain fluid test samples from different types of bodies of water or other fluids.

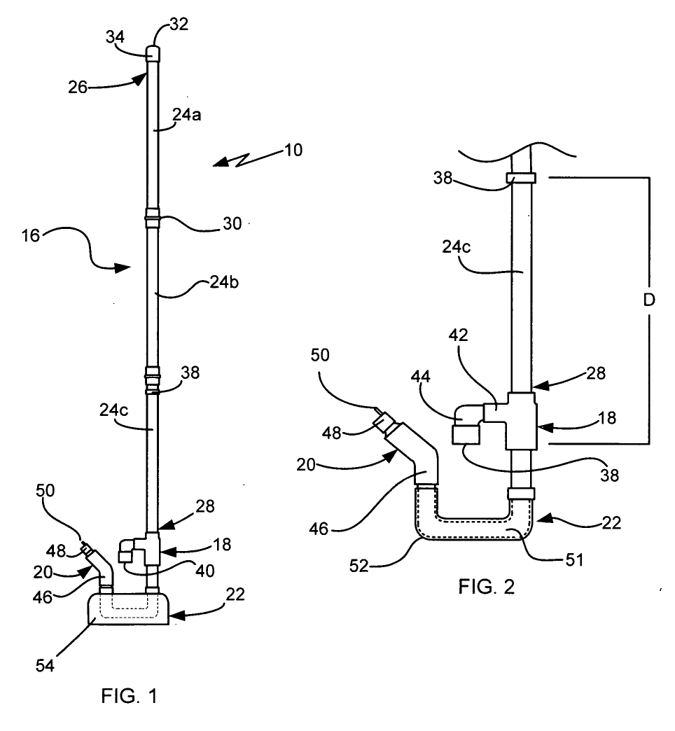

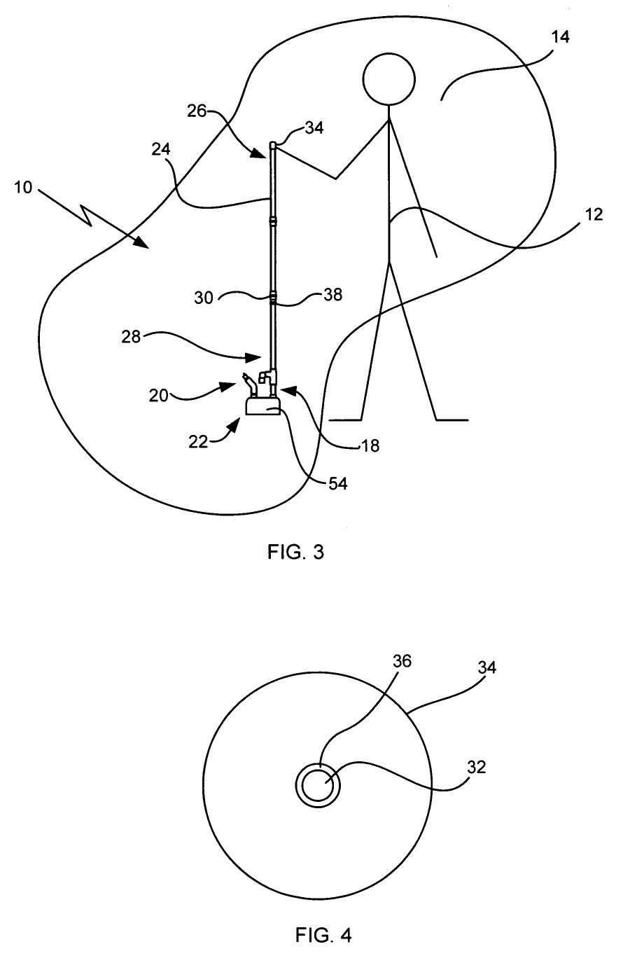

A water test sample retrieval tool that is manufactured out of the components and configured pursuant to a preferred embodiment of the present invention is shown generally as 10 in the figures. As best shown in FIG. 3, water test sample retrieval tool 10 can be utilized by a user 12 to obtain a sample of water from a body of water 14, such as swimming pool, by lowering a portion of tool 10 into the water 14 and collecting a sample of the water 14 in tool 10 so that user 12 can use the sample for testing purposes. A preferred configuration of the tool 10 of the present invention is shown in FIGS. 1 and 2. As set forth in these figures, water test sample retrieval tool 10 generally comprises a handle section 16, an inlet section 18, an outlet section 20 and a storage section 22. As set forth in more detail below, handle section 16 is held by the user 12 to lower inlet section 18 to the desired depth in water 14 so that a sample of water 14 can be collected in storage section 22, retrieved from the water 14 and then poured out of outlet section 20 into a water test bottle or other container (not shown) for performing chemical tests on the water sample. The various sections of tool 10 function together to provide an easy to use, versatile water test sample retrieval tool 10 that allows the user 12 to obtain the sample from the desired depth D, shown in FIG. 2, in water 14 without kneeling or laying at the edge of water 14 and without the need to place his or her arm into water 14.

In a preferred embodiment of the present invention, handle section 16 comprises a tubular handle 24 having a closed upper end 26 and an open lower end 28. In the embodiment shown in FIGS. 1 through 3, tubular handle is made up of first or upper handle member 24a, second or middle handle member 24b and third or lower handle member 24c that are threadably joined by tubular connectors 30 to form a contiguous handle 24. In the preferred embodiment, first 24a, second 24b and third 24c handle members are removably connected by tubular connectors 30 so as to provide a providing a multiple-piece handle section 16 such that handle 24 only has to be threaded together to provide a sufficiently long handle section 16 so user 12 can obtain the sample from water 14 while in a generally upright or standing position (as shown in FIG. 3). First handle member 24a can be separated from second handle member 24b, which can be separated from third handle member 24c for ease of storage and, as set forth in more detail below, to simplify use of tool 10 when pouring water from tool 10 into a chemical test kit bottle or other container. In the preferred configuration, handle 24 is made out of a generally lightweight and durable material which is generally both UV and corrosion resistant, such as plastic, PVC, composite or other suitable materials. Those skilled in the art will readily understand that handle 24 can be made as a single integral unit, that it can comprise two or more separatable sections or that it can be made in a telescoping configuration which is configured to extend or collapse as desired. In addition, those skilled in the art will understand that handle members 24a, 24b and 24c can connect in a manner other than being threadably engaged and that handle 24 can be made out of different materials than those described or referenced above.

To facilitate effective use of tool 10, the closed upper end 26 of handle section 16 has a pressure control hole 32 therein, as best shown in FIG. 4. As explained in more detail below, pressure control hole 32 is utilized, by closing hole 32, to prevent the entry of water into inlet section 18 until tool 10 is lowered to the desired depth in water 14 and then is utilized, by opening hole 32, to allow water from the desired depth D to flow into storage section 22 to collect a sample of water in tool 10 for use for chemical analysis. In the configuration shown in the figures, upper end 26 of handle 24 has cap member 34 at the end that is fixedly attached to handle 24 to close the end thereof and pressure control hole 32 is located in cap member 34. Preferably, pressure control hole 32 is sized and configured such that the user 12 can place his or her thumb or other finger over hole 32 to seal the chamber (not shown) in handle 24 to control the flow of water into inlet section 18. In one configuration, pressure control hole 32 is approximately one-fourth an inch in diameter and has a recessed area 36 around it to provide a smooth, easily sealable opening for user 12. As will be readily apparent to those skilled in the art, pressure control hole 32 can be located anywhere on handle 24 that will be above the surface of the body of water 14 when tool 10 is inserted therein to obtain the desired sample of water. For instance, pressure control hole 32 can be located on the side of first handle section 24a near the upper end 26 of handle 24 where user 12 can easily close and open hole 32 with the thumb or a finger when he or she is obtaining the water sample from the body of water 14. In another configuration, second end 26 of handle 24 is provided with a closed wall across the end, thereby eliminating the need for cap member 34 to close second end 26.

To further facilitate effective use of tool 10, handle section 16 also comprises a depth marker or marking device, shown as 38, to indicate how deep tool 10 must be lowered into water 14 for inlet section 18 to collect a water test sample from the recommended or desired depth, shown as D in FIG. 2. In the configuration shown in the figures, depth marker 38 is a collar that is fixedly mounted onto third handle member 24c at the recommended depth D of eighteen inches above inlet 40 so that when depth maker 38 is at the surface, inlet 40 is at the recommended depth D (i.e., eighteen inches). In an alternative embodiment, handle section 16 is provided with marked graduations along handle 24 to indicate various depth levels and/or is provided with an adjustable mechanism for depth marker 38 that slides on handle 24 to be positioned at the depth level D desired by user 12. Such an adjustable mechanism can comprise a slidable collar having a screw, bolt, clamp or other engagement member that allows the slidable collar to be clamped to the desired location on handle 24, typically in third handle section 24c. Handle section 16 can also be provided with a removable marking mechanism, such as tape or other marking devices as depth marker 38, that the user applies to third handle member 24c, or elsewhere on handle 24, to indicate to himself or herself where the surface of the water 14 should be located when inlet section 18 is sufficiently lowered in water 14 so that user 12 can obtain a water test sample from the desired depth D therein. Those skilled in the art will appreciate and recognize that a number of different marking mechanisms are useable as depth marker 38 for the water test sample retrieval tool 10 of the present invention.

As shown in the figures, inlet section 18 is attached or otherwise located at lower end 28 of handle section 16 (i.e., at the lower end of third handle section 24c) and configured with inlet 40 that is adapted to receive water from the water body 14. In the preferred embodiment, inlet section 16 comprises an outwardly extending portion 42 that is configured to position inlet 38 a short distance away from handle section 16 and a downwardly extending portion 44 (as best shown in FIG. 2) that places inlet 40 at desired depth D below depth marker 38. In this manner, as explained in more detail below, water from the body of water 14 will not enter into the storage section 22 until inlet 40 is at the desired depth level D in water 14. In the configuration shown in the figures, inlet section 18 is a separate member that is made out of PVC pipe or other material (i.e., the same as handle section 16) and inlet 40 is completely open. The outwardly extending portion 42 of inlet section 18 is part of a T-shaped tubular component and downwardly extending portion 44 is a 90° elbow. During use of tool 10, the air pressure inside tubular handle 24 obtained with pressure control hole 32 closed off by user 12 is sufficient to prevent water from the surface of the body of water 14 or elsewhere above the desired sample depth D from flowing into inlet 40 while inlet section 18 is being lowered into the water 14. As explained in more detail below, when the sample is obtained at the desired depth D, after the user 12 releases his or her thumb from pressure control hole 32, the excess water in handle 24 (that amount above inlet section 18) will drain out through inlet 40 into the body of water 14 as user 12 pulls tool 10 out of water 14. As known to those skilled in the art, inlet section 18 can be configured differently and with different materials than set forth above and still obtain the benefits for tool 10 of the present invention.

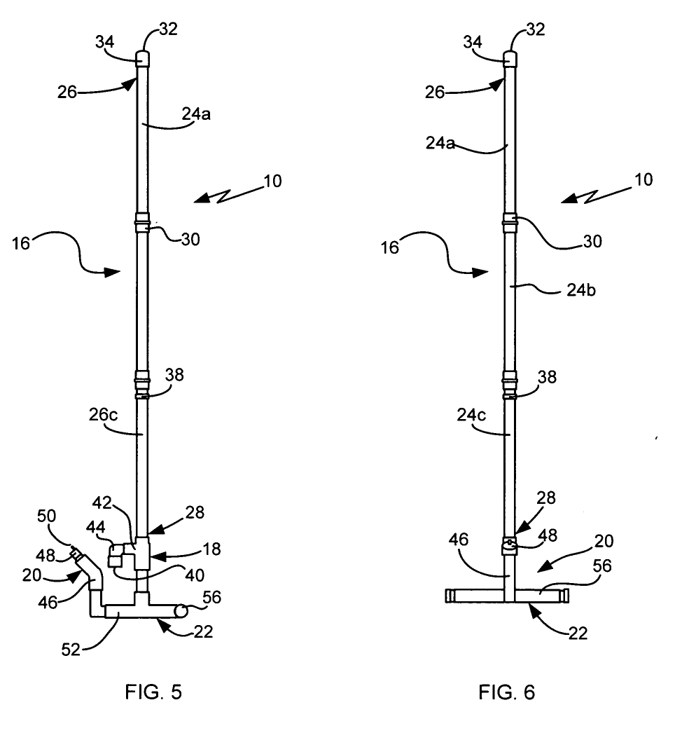

Although outlet section 20 can be configured in a number of different ways, in the preferred embodiment outlet section 20 comprises an outwardly and upwardly extending portion 46 having an outlet spout 48 with an outlet opening 50 at the end thereof that is configured for ease of pouring water from tool 10 into a test bottle, test kit or other container for performing chemical analysis on the water sample obtained with tool 10. In one configuration, as shown in FIG. 5, upwardly extending portion 46 first extends outward from storage section 22 to assist in providing support for tool 10 when it is placed on a flat surface (as described below). In a preferred embodiment, outlet spout 48, having outlet 50, is of the type that is commonly utilized on sport bottle drinks, shampoo bottles and the like that is of a cap-type configuration having a flip-up or flip-out portion that is closed when fluid is desired to be contained and which is extended when it is desired to pour fluid from outlet 50. These types of plastic spout caps are commonly available and their use is well known by most people, including those who are likely to be using tool 10. As with the above components, upwardly extending portion 46 and outlet spout 48 can be made out of PVC pipe or like material that is generally lightweight, durable and corrosion resistant.

The storage section 22 of tool 10 is configured to receive and store the water test sample retrieved through inlet 40 when tool 10 is lowered into the body of water 14. In the embodiment best shown in FIG. 2, storage of the water test sample is achieved through the use of one or more tubular members 52 at storage section 22, as well as the components for inlet section 18 and upwardly extending portion 46. Water from the body of water 14 flows into tool 10 through inlet 40 and then into the interior fluid storage chamber 51 defined by tubular member 52 of storage section 22 and, at least initially, into upwardly extending portion 46 and at least a portion of third handle member 24c. In one embodiment, storage section 22 is made up of two interconnected tubular members 52. In another configuration, a single tubular member 52 is utilized for storage section 22. Generally, for use to obtain a water test sample for a swimming pool, spa or other like body of water 14, fluid storage chamber 51 of tubular member 52 does not have to provide very much storage as usually only a small amount of fluid is necessary for chemical testing purposes.

In the preferred embodiment of the present invention, shown in FIGS. 1 through 3, the lower end of tool 10 is provided with a base member 54 that is configured to support tool 10 in a generally upright manner when it is placed on the top of a table, on a bench seat or other generally flat surface. In the embodiment shown, base member 54 has a generally square or rectangular footprint and is made out of plastic or another lightweight, durable, corrosion resistant material. With base member 54, or another support mechanism, the user 12 can set tool 10 down while he or she is preparing the test materials for chemical testing or between performing different tests. Without being configured to stand upright, the user 12 would have to lay tool 10 down, which could result in water spilling out of storage section 22, or hold tool 10 with his or her leg or against another object or grasp handle section 16 with one hand while performing the desired tests with the other hand. In an alternative embodiment, shown in FIGS. 5 and 6, the lower end of tool 10 is provided with one or more support members 56 that extend outwardly from tubular member 52 of storage section 22. Support members 56 can comprise tubular components that are made out of plastic, PVC pipe or other material having generally lightweight, durable, UV resistant and corrosion resistant properties. Any base member 54 or support members 56 utilized with tool 10 should be configured so as to not prevent lowering of tool 10 into the water 14 or substantially interfere with the flow of water to inlet 40.

In one embodiment, handle members 24a, 24b and 24c are approximately sixteen inches long and made out of three-fourths inch diameter tubular plastic pipe that are interconnected with PVC tubular connectors. Inlet section 18, outlet section 20, storage section 22 and cap member 34 can also be made out of PVC tubular pipe. Tubular member 52 of storage section can be approximately four inches long. Depth marker 38 can be a collar positioned on third handle member 24c that is located eighteen inches, or other desired depth D, above inlet 40. Although the inventors of the present invention have found that the use of one-half to three-quarters of an inch diameter plastic or PVC pipe works well for tool 10 of the present invention with regard to strength, durability and weight, other materials are also suitable for use with tool 10. The above-referenced dimensions and materials are for exemplary purposes only and are not intended to limit the present invention in any way.

In use, if handle section 16 is provided with multiple handle sections, such as first 24a, 24b and third 24c handle sections, the user 12 connects the handle sections together or otherwise extends handle section 16 so that user 12 has a handle 24 of sufficient length such that he or she can lower inlet section 18 of tool 10 into the body of water 14 while standing upright, as shown in FIG. 3. To substantially prevent the entry of water into storage section 22 through inlet 40 of inlet section 18 from the surface of the body of water 14, user 12 places his or her thumb or finger over pressure control hole 32, whether located on cap member 34 or elsewhere, as he or she lowers inlet section 18 of tool 10 to the desired depth D for the water sample. The user 12 lowers tool 10 into the water 14 until the depth marker 38, such as the collar on third handle member 24c, is approximately at the surface of the water 14. At that time, inlet 40 will be approximately at the desired depth D from which to obtain a sample of water 14. By lifting the thumb or finger off of pressure hole 32 for a few seconds (i.e., approximately three to six seconds), a sufficient amount of water from the desired depth will flow into fluid storage chamber of tubular member 52 at storage section 22 through inlet 40 of inlet section 18 for the user 12 to use with the test kit or other chemical testing method. The user 12 then raises tool 10 out of the body of water 14, preferably with pressure control hole 32 left open to allow any excess water in handle 24 drain out through inlet 40. Due to the configuration of storage section 22 below inlet 40, the test sample water from the desired depth D will remain inside fluid storage chamber 51 of tubular member 52.

Once user 12 obtains the water test sample, he or she sets base 54 or support members 56 of tool 10 on a table, bench seat, pool deck or other generally flat surface to perform the desired tests. After opening outlet spout 48, as may be appropriate for the configuration of outlet spout 48, water from tool 10 is poured out fluid storage chamber 51 of tubular member 52 through outlet 50 at the end of outlet spout 48 on upwardly extending portion 46 into a chemical test kit bottle or other container to perform the desired chemical tests. Any extra or remaining water in tool 10 can be utilized to rinse out the test equipment and/or rinse off the user's hands. For ease of handling when pouring water from tool 10, the user 12 may prefer to disengage first 24a and/or second 24b handle members of handle 24 from the third handle member 24c to provide a less unwieldy tool 10 while pouring water out of outlet 50. As discussed above, it is preferred that the components of tool 10 be made out of generally lightweight, durable, UV resistant and corrosion resistant materials due to its intended use for raising/lowering into a body of water 14 and in a wet, outdoor environment.

Various alternative configurations are possible for tool 10 of the present invention. For instance, upper end 26 of handle 24 can be provided with a mechanism for closing and opening pressure control hole 32 so the user 12 does not have to utilize his or her thumb or finger for this operation. Inlet 40 can be provided with a screen or other semi-blocking member to prevent the inflow of debris into inlet section 18 when tool 10 is lowered into the body of water 14. This may be particularly important for lakes, streams or the like. Outlet 50 can be located directly on or at the end of tubular member 52, thereby eliminating upwardly extending portion 46. In addition, outlet spout 48 can be of the type that is rotated or otherwise turned to open outlet 50 instead of the flip-up type shown in the figures. If desired, outlet section 20 can be configured with a removable storage bottle, which either functions as fluid storage chamber 51 or hydraulically connects to fluid storage chamber 51 in tubular member 52, that is removed from outlet section 20 to pour the water test sample into a chemical test kit or the like, thereby eliminating the need for the user 12 to dismantle handle 24 to pour the water sample out of tool 10. Instead of being threadably connected, handle members 24a, 24b and 24c can be connected by other mechanism appropriate for tubular members. Although base 54 or support members 56 are preferred to stand tool 10 upright, in some applications this may not be necessary or even desirable.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A water test sample retrieval tool for obtaining a sample of fluid from a body of fluid, said tool comprising:
an elongated tubular handle having a closed upper end and an open lower end;
an inlet section at said lower end of said handle, said inlet section having an inlet for receiving said sample of fluid from said body of fluid;
an outlet;
a fluid storage chamber disposed between said inlet and said outlet, said fluid storage chamber configured to store said sample of fluid; and
means in said handle for controlling entry of said sample of fluid into said fluid storage chamber through said inlet.

2. The water test sample retrieval tool according to claim 1, wherein said handle comprises a plurality of handle members, said handle members releasably connected to define said handle.

3. The water test sample retrieval tool according to claim 1 further comprising means for supporting said tool in a generally upright position.

4. The water test sample retrieval tool according to claim 3, wherein said supporting means comprises a base member.

5. The water test sample retrieval tool according to claim 4, wherein said fluid storage chamber is disposed in said base member.

6. The water test sample retrieval tool according to claim 3, wherein said supporting means is one or more support members attached to said fluid storage chamber.

7. The water test sample retrieval tool according to claim 1, wherein a tubular member disposed between said inlet section and said outlet defines said fluid storage chamber.

8. The water test sample retrieval tool according to claim 1 further comprising a depth marker attached to said handle, said depth marker configured to define a preferred depth to obtain said sample of fluid from said body of fluid.

9. The water test sample retrieval tool according to claim 8, wherein said depth marker is a collar on said handle.

10. The water test sample retrieval tool according to claim 1, wherein said inlet section further comprises an outwardly extending portion disposing said inlet outwardly of said handle.

11. The water test sample retrieval tool according to claim 10, wherein said inlet section further comprises a downwardly extending portion disposing said inlet generally downward.

12. The water test sample retrieval tool according to claim 1, wherein said inlet is disposed generally downward.

13. The water test sample retrieval tool according to claim 1 further comprising an upwardly extending member disposed between said fluid storage chamber and said outlet to extend said outlet upwardly from said fluid storage chamber.

14. The water test sample retrieval tool according to claim 1, wherein said controlling means is a pressure control hole in said handle.

15. The water test sample retrieval tool according to claim 14, wherein said pressure control hole is disposed in a cap member at said upper end of said handle.

16. A water test sample retrieval tool for obtaining a sample of fluid from a body of fluid, said tool comprising:
an elongated tubular handle having a closed upper end and an open lower end;
an inlet section at said lower end of said handle, said inlet section having an inlet for receiving said sample of fluid from said body of fluid, said inlet disposed generally downward;
an outlet;
a storage section having a fluid storage chamber disposed between said inlet and said outlet, said fluid storage chamber configured to store said sample of fluid; and
a pressure control hole in said handle for controlling entry of said sample of fluid into said fluid storage chamber through said inlet.

17. The water test sample retrieval tool according to claim 16 further comprising means for supporting said tool in a generally upright position.

18. The water test sample retrieval tool according to claim 16 further comprising a depth marker attached to said handle, said depth marker configured to define a preferred depth to obtain said sample of fluid from said body of fluid.

19. The water test sample retrieval tool according to claim 16, wherein said pressure control hole is disposed at said upper end of said handle.

20. A water test sample retrieval tool for obtaining a sample of fluid from a body of fluid, said tool comprising:
an elongated tubular handle having a closed upper end and an open lower end, said handle comprising one or more connected tubular handle members;
an inlet section at said lower end of said handle, said inlet section having an inlet for receiving said sample of fluid from said body of fluid, said inlet disposed generally downward;
an outlet section having an outlet;
a storage section having a tubular member disposed between said inlet and said outlet, said tubular member defining a fluid storage chamber therein, said fluid storage chamber configured to store said sample of fluid;
a pressure control hole in said handle for controlling entry of said sample of fluid into said fluid storage chamber through said inlet;
a depth marker attached to said handle, said depth marker configured to define a preferred depth to obtain said sample of fluid from said body of fluid; and
means for supporting said tool in a generally upright position.
